(19) United States
(12) Patent Application Publication
(10) Pub. No.: US 2007/0149193 A1
(43) Pub. Date: Jun. 28, 2007

(54) WIRELESS MOBILE COMMUNICATION DEVICE WITH SERVICE SELECTION LOGIC

(76) Inventor: Jimmy Chong, Toronto (CA)

Correspondence Address: FETHERSTONHAUGH - SMART & BIGGAR, 1000 DE LA GAUCHETIERE WEST, SUITE 3300, MONTREAL, QC, H3B 4W5, CA

(21) Appl. No.: 11/613,374

(22) Filed: Dec. 20, 2006

(30) Foreign Application Priority Data
Dec. 22, 2005 (CA) 2,531,306

(51) Int. Cl. H04Q 7/20

(52) U.S. Cl. 455/435.2

(57) ABSTRACT

A wireless device capable of acquiring service from multiple wireless entities operating according to at least two different wireless communication standards. In a specific non-limiting example, the wireless communication standards provide different service attributes to the user of the wireless device. For example, each standard can be adapted to provide specific services to the user such as voice, video or data, or combinations thereof. A specific example of wireless communication standards that can be used are standards based on the Code Division Multiple Access (CDMA) communication technology. In a more specific example the first wireless communication standard is CDMA 2000 1× that provides voice and data services and the second wireless communication standard is CDMA 2000 Evolution Data Only (EvDO) providing data only services but at a higher rate than CDMA 2000 1×.

### FIELD OF THE INVENTION

The invention relates to wireless communication systems and more particularly to a mobile wireless communication device with service selection logic.

### BACKGROUND OF THE INVENTION

A typical wireless communication device, such as a cellular telephone is intended to be operated in an environment where service is available from several service providers. Typically, the telephone uses some type of functionality that will select the service provider to use among multiple providers currently available in the geographical location in which the telephone is located. For instance, telephones using the Code Division Multiple Access (CDMA) technology are programmed with a Preferred Roaming List (PRL) table that will determine which service provider the telephone will use depending on the geographic location in which the telephone is located. A PRL table may contain many entries indicating, for a given geographical region, which service provider is the most preferred and if service cannot be acquired from that most preferred service provider, which other service provider to use. Basically, the PRL table reflects the business relationships established between different service providers and forces the mobile telephone to acquire service from a set of specific service providers such that the user can benefit from a reduced cost of operation. The PRL table may also include entries that deny service acquisition from certain service providers in a given geographic area. Those service providers may be organizations with whom the “home” service provider (the service provider to whom the user pays the bills for the cellular telephone usage) has no relationships whatsoever.

A problem may arise when the mobile telephone is designed to obtain services over two different networks, specifically networks that are characterized by different service attributes. An example of service attribute difference is a situation where one of the networks provides voice and data communications to the user while the other network is a “data only” network capable of providing data rates significantly higher than what the first network offers.

The service selection functionality currently implemented in wireless mobile communication devices is not entirely satisfactory particularly in the context where the mobile communication device has the option of obtaining service from different entities. Accordingly, a need exists to develop a wireless communication device and associated components allowing for more sophisticated service acquisition strategies.

### SUMMARY OF THE INVENTION

In broad terms, the invention provides a wireless device capable of acquiring service from multiple wireless entities operating according to at least two different wireless communication standards. In a specific non-limiting example, the wireless communication standards provide different service attributes to the user of the wireless device. For example, each standard can be adapted to provide specific services to the user such as voice, video or data, or combinations thereof. A specific example of wireless communication standards that can be used are standards based on the Code Division Multiple Access (CDMA) communication technology. In a more specific example the first wireless communication standard is CDMA 2000 1× that provides voice and data services and the second wireless communication standard is CDMA 2000 Evolution Data Only (EvDO) providing data only services but at a higher rate than CDMA 2000 1×.

Many different types of wireless devices can benefit from this invention, such as mobile telephones, portable computers having wireless communication capabilities, wireless devices capable of sending and/or receiving e-mail, Personal Digital Assistants (PDAs), wireless devices capable of receiving and playing video and gaming devices, among others.

The wireless device has a data storage area for holding a data structure containing preference information indicating that one wireless entity is more desirable than another wireless entity. In addition, the mobile communication device includes a selection logic that uses the preference information in selecting the wireless entity from which service is to be acquired.

In one non-limiting example of implementation, when the wireless device is in a state of acquiring service from a wireless entity operating according to the first wireless communication standard and the user desires obtaining service based on the second wireless communication standard, the selection logic is invoked to select a wireless entity among the available wireless entities based on the second wireless communication standard. In another non limiting example of implementation, when the wireless device has already acquired service from a wireless entity, the selection logic will attempt determining if service has become available from another wireless entity that is indicated in the data structure as being more desirable than the current wireless entity.

In a yet another non-limiting example of implementation, the wireless device is a mobile telephone including a timer function to cause the service selection logic to periodically perform the search for a more desirable wireless entity. This is useful when the user is traveling and may enter a geographical area where a preferred wireless entity, that was not previously available, now becomes available. In this fashion, the mobile telephone can provide increased service selection flexibility that can result in more competitive wireless access solutions for the user.

In another non-limiting example of implementation, the service selection logic is designed to cause the wireless device to automatically acquire service from a more preferred wireless entity, when such wireless entity has been identified.

Another possible variant is to invoke the service selection logic to search for a more preferred wireless entity only when the current wireless entity is not the most preferred wireless entity identified in the data structure.

Therefore, as embodied and broadly described herein, the invention provides a wireless device capable of acquiring service from at least two wireless entities, the wireless device including a data storage area for holding a data structure that contains: information about a first set of wireless entities, the first set being based on a first wireless communication standard to deliver wireless service; information about a second set of wireless entities, the second set being based on a second wireless communication standard to deliver wireless service, wherein the first wireless communication standard is different from the second wireless communication standard; first preference information indicating that one of the wireless entities from the first set is more desirable than another one of the wireless entities from the first set; second preference information indicating that one of the wireless entities from the second set is more desirable than another one of the wireless entities of the second set.

The wireless device also includes selection logic operable for: using the first preference information in selecting a wireless entity from the first set of wireless entities; using the second preference information in selecting a wireless entity from the second set of wireless entities.

As embodied and broadly described herein the invention also encompasses a computer readable storage medium for program data for execution by a processor of a wireless device. The wireless device has a data storage area for holding a data structure, containing: information about a first set of wireless entities, the first set being capable of delivering wireless service based on a first wireless communication standard; information about a second set of wireless entities, the second set being capable of delivering wireless service based on a second wireless communication standard, different than the first wireless communication standard; first preference information indicating that one of the wireless entities from the first set is more desirable than another one of the wireless entities from the first set; second preference information indicating that one of the wireless entities from the second set is more desirable than another one of the wireless entities of the second set.

The program data when executed by the processor of the wireless device implements a selection logic operable for: using the first preference information in selecting a wireless entity from the first set of wireless entities; using the second preference information in selecting a wireless entity from the second set of wireless entities.

As embodied and broadly described herein the invention also encompasses a mobile cellular telephone capable of wireless communications based on a first wireless communication standard and on a second wireless communication standard, wherein: a) the first wireless communication standard is CDMA based and supports voice and data communications; b) the second wireless communication standard is CDMA based and supports data only communications, the second wireless communication standard allowing a higher data transfer rate with the mobile cellular telephone than the first wireless communication standard; c) service based on the second wireless communication standard can be provided to the mobile telephone by two or more service providers, the mobile telephone comprising: (i) a data storage area for holding information about a plurality of service providers and information indicating that one service provider is more desirable than another service provider; (ii) service provider selection logic for processing information in the data storage area to determine when the mobile telephone has acquired service from one service provider, if service can also be acquired from another service provider that is indicated in the data storage area as being more desirable than the one service provider.

As embodied and broadly described herein the invention also encompasses a method for selecting a wireless entity for the delivery of service to a wireless communication device, the method comprising: selecting a wireless entity from a first set of wireless entities using first preference information, the first set of wireless entities operating according to a first wireless communication standard to deliver wireless service, and the first preference information indicating that one of the wireless entities from the first set is more desirable than another one of the wireless entities from the first set; and selecting a wireless entity from a second set of wireless entities using second preference information, the second set of wireless entities operating according to a second wireless communication standard to deliver wireless service, and the second preference information indicating that one of the wireless entities from the second set is more desirable than another one of the wireless entities from the second set.

Without intent of being bound by any specific definition, a wireless entity that delivers service to a wireless device according to a certain wireless standard can be the physical network that transports the signals to be transmitted to the wireless device or received from the wireless device or portions of a network. For example, when the wireless device is in a geographic region where several networks exist that can deliver wireless services to the device, those networks are considered as wireless entities. The wireless networks can be of a cellular type, defining areas or cells of generally limited geographical coverage, where calls are handed from one cell to the other as the wireless device transits between cells. Typically, a cellular infrastructure uses Radio Frequency (RF) communications in a licensed bandwidth of the spectrum. Wireless networks can also use a WiFi (trademark) technology or other technologies. WiFi uses unlicensed bandwidth to provide short range (significantly shorter than cellular) high speed data connections between mobile wireless devices and nearby WiFi access points, usually referred to as “hotspots”.

The service provider, in other words, the business organization that operates or owns the wireless networks and that provides the communication services to customers for a fee, can also be considered as a wireless entity.

### BRIEF DESCRIPTION OF THE DRAWINGS

A detailed description of examples of implementation of the present invention is provided below with reference to the following drawings, in which:

FIG. 1 is a functional block diagram of a mobile telephone embodying the principles of the present invention;

FIG. 2 is a diagram illustrating the operation of the mobile telephone shown in FIG. 1;

FIG. 3 is a flowchart illustrating in general the operation of the service provider selection logic of the mobile.

In the drawings, embodiments of the invention are illustrated by way of example. It is to be expressly understood that the description and drawings are only for purposes of illustration and as an aid to understanding, and are not intended to be a definition of the limits of the invention.

### DETAILED DESCRIPTION

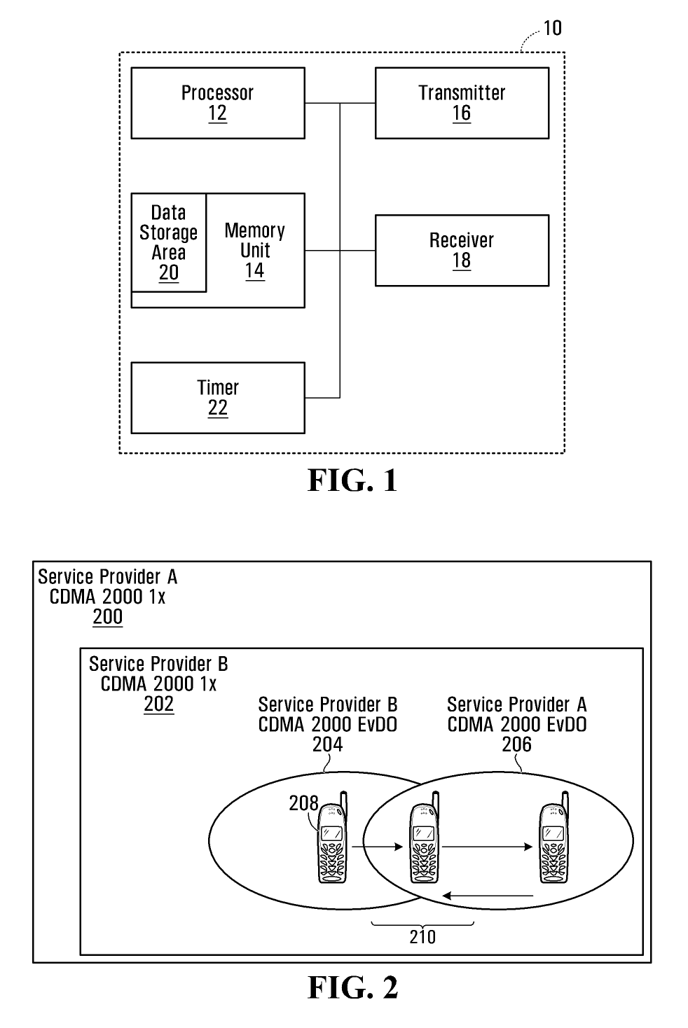

The functional block diagram of FIG. 1 illustrates a wireless device, such as a cellular mobile telephone 10. Note that the wireless device does not necessarily need to be a telephone but can also be implemented by any other type of device that is mobile and can establish a communication session in a wireless manner, to receive and/or transmit voice, data or both. Examples of such wireless devices include portable computers having wireless communication capabilities, wireless devices capable of sending and/or receiving e-mail, Personal Digital Assistants (PDAs), wireless devices capable of receiving and playing video, gaming devices and vehicular devices, among others.

The mobile telephone 10 includes a processor 12 and a memory unit 14. The processor 12 is designed to control the mobile telephone 10 by executing instructions of a program stored in the memory 14. The memory 14 may be constructed in a number of possible ways, and may include a Random Access Memory (RAM), a Read Only Memory (ROM), a non-volatile RAM or ROM, among other possibilities.

The mobile telephone 10 includes a transmitter 16 and a receiver 18 that operate in a manner known in the art and for that reason they will not be described in greater detail here. In the specific example of implementation that will be discussed below, the mobile telephone 10 is capable of communicating with wireless entities according to at least two different wireless communication standards. Accordingly, the receiver 18 and the transmitter 16 are designed to handle this functionality. This may imply that the receiver 18 includes at least two separate units that may or may not share components, where each unit operates according a respective wireless communication standard. The transmitter 16 is constructed in the same fashion.

The mobile telephone 10 also includes a data storage area 20 for storing a data structure. The data structure contains information which determines the wireless entity from which service will be acquired, depending on the geographical area in which the mobile telephone 10 is located. An example of such data structure that is used in CDMA systems is the so called Priority Roaming List (PRL). In a specific example of implementation, the PRL establishes for a given geographic region, a list of service providers from which the mobile telephone 10 can acquire service and ranks the service providers in terms of priority. The concept of a PRL is well known in the industry and for that reason it will not be discussed in detail.

The data storage area 20 will normally be part of the memory 14.

The software stored in the memory 14 implements a service provider selection logic that uses the information stored in the PRL to determine the service provider from which communication services will be obtained. The following specific example will illustrate the operation of the service provider selection logic.

Assume that the mobile telephone 10 operates according to two different wireless communication standards, both based on Code Division Multiple Access (CDMA). In a specific example, the first wireless communication standard is CDMA 2000 1× supporting voice and data communications. The second wireless communication standard is CDMA 2000 Evolution Data Only (EvDO). For the purpose of reference, the CDMA 2000 1× standard is based on the IS-2000 specifications while the CDMA 2000 EvDO standard is based on the IS-856 specifications. The CDMA 2000 EvDO standard is designed to provide the mobile telephone 10 with a data only service at a much higher rate than the CDMA 2000 1× standard. CDMA 2000 EvDO access is normally used specifically for applications running on the mobile telephone 10 that demand high data rates, such as for example downloading video.

An example of a PRL table stored in the memory 14 is shown below. The example is very much abbreviated when compared to a real PRL table that contains many more entries, perhaps several hundreds. However, for the purpose of this specification, the details of the PRL that are shown will suffice to illustrate the principles of the invention.

The PRL table includes a plurality of entries (rows). Each entry refers to a specific RF environment in which communication services can be obtained from a specific service provider. Entries in which the System Identifier “SID” and Network Identifier “NID” are not blanked correspond to wireless entities operating according to the CDMA 2000 1× standard. The RF environment for such wireless entities is characterized by the SID, NID and Acquisition Index “ACQ IND” data. In other words, each CDMA 2000 1× entry contains a unique SID, NID and ACQ IND combination. The RF environment for CDMA 2000 EvDO entries is characterized by a unique combination of Sub Network Identifier “Sub NetID” and ACQ IND.

Each entry of the PRL table usually corresponds to a service provider from which communication services can be obtained over the RF environment the entry specifies. In a specific and non-limiting example of implementation a service provider is a wireless operator that will charge for the delivery of wireless services to the mobile telephone 10.

In use, the service provider selection logic will run through the various entries in determining which service provider will be used for acquiring communication services. Strategies may be implemented to reduce the number of entries that the service provider selection logic must process, such as to speed up connection to the network. Those strategies, however, are not part of the present invention.

The “GEO” column refers to the geographic area in which the mobile telephone 10 is located. The first entry is associated with a new geographic region “New” while the remaining entries “Same” show that they all are within the same geographic region that the first entry.

The “PRI” column refers to the relative preference of using one service provider versus another one. For example, the second entry is associated with a service provider that is considered more desirable “more” than a service provider having a “same” priority. Specifically, a “same” indication designates a service provider that has the same order of preference than the following series of service providers up until a service provider is designated with “more”. In other words, service providers with “same” have the same priority or desirability as those service providers below the “same” up to and including the next service provider characterized with “more”.

Generally, in a situation where the mobile telephone 10 can acquire service from two or more service providers, it will connect to the one that is indicated in the PRL table as being more desirable than the other available service providers. In practice, this can be implemented by causing the service provider selection logic to attempt connecting first with service providers that are labeled as being more preferable. If no connection is possible with anyone of those service providers or connection is below an acceptable quality threshold, the mobile telephone 10 will attempt acquiring service from less preferred service providers. If no connection at this level is possible, the mobile telephone 10 continues further down the priority list.

The “ACQ IND” lists for each entry a channel number or a block of channel numbers from which the mobile telephone 10 may attempt acquiring service.

The “ASSN INC” determines if a CDMA 2000 EvDO entry is associated with a CDMA 2000 1× entry. “Yes” implies association and “No” means no association or linking. Specifically, consider the 5^{th}, 6^{th} and 7^{th} entries in the PRL table. They all designate CDMA 2000 EvDO entries and they are all linked to a CDMA 2000 1× entry since the “ASSN INC” is set to “Yes” for each entry.

The “ASSN TAG” provides linkage information that determines which CDMA 2000 EvDO service providers are associated with which CDMA 2000 1× service providers(s). Referring back to the example of the 5^{th}, 6^{th} and 7^{th} entries, they all have the same “ASSN TAG” which is 0. Accordingly, the 5^{th}, 6^{th} and 7^{th} entries form a subset of all the entries in the PRL table relating to the CDMA 2000 EvDO service providers that are linked to CDMA 2000 1× service providers having the same “ASSN TAG”. In this example, those CDMA 2000 1× service providers correspond to entries 1 to 4 and 8 in the PRL table.

The entries in the table for which the “SubNetID”, the “PN ASSN” and “DATA ASSN” fields are blanked correspond to CDMA 2000 1× service providers. In contrast entries in which those fields contain information correspond to CDMA 2000 EvDO service providers.

Association fields are used to enable the designation of associated systems. Pseudo Random Association “PN ASSN” indicates whether the CDMA 2000 1× and CDMA 2000 EvDO entries have or have NOT the same PN offset value used in CDMA 1× entries. “DATA ASSN” is used to indicate whether CDMA 2000 1× and CDMA 2000 EvDO entries are using the same Packet Data Serving Node (PDSN).

SubNetID is an identifier used in CDMA 2000 EvDO entries based on the Internet Protocol version 6 addressing scheme.

The operation of the mobile telephone 10 will now be described in connection with FIG. 2. Block 200 denotes a geographical area in which the mobile telephone 10 can acquire service based on the CDMA 2000 1× standard from service provider A. Area 200 encompasses area 202 that is smaller and where the mobile telephone 10 can also acquire service based on the CDMA 2000 1× standard from service provider B. In other words, when the mobile telephone 10 is outside the area 202 it can only acquire service based on the CDMA 2000 1× standard from service provider A. However, when the mobile telephone 10 is within the area 202, it can also acquire service based on the CDMA 2000 1× standard from service provider B. The choice between service providers A and B is resolved by the service provider selection logic that processes the information in the PRL table. Assume for the sake of this example that in the table service provider B is listed as being preferred over service provider A. In such instance, the mobile telephone 10 will acquire service according to the CDMA 2000 1× standard from the service provider B when being in the area 202. Note that there are many ways to express the preference information in the PRL table none of which is critical to the present invention. Accordingly, the specific example of the manner in which preference information is expressed in the PRL table shown earlier should not be interpreted in a limiting manner since many other options can be used without departing from the spirit of the invention.

Now assume that the mobile telephone 10 has acquired service according to the CDMA 2000 1× standard from service provider A while being outside the 202 area. If the mobile telephone 10 has now moved within the area 202, the service provider selection logic that is designed to periodically “hunt” for a more preferred service provider will cause the mobile telephone 10 to switch such that service according to the CDMA 2000 1× standard will now be obtained from service provider B, that is indicated in the PRL table as being more desirable. This is accomplished by using the timer 22 shown in FIG. 1 that periodically invokes the service provider selection logic. The intervals at which the service provider logic is invoked can vary and are normally designed according to the specific application. For instance they can range from several seconds to several minutes or more. Once the mobile 10 moves within the area 202 and the service provider B becomes available, the service provider logic having been triggered by the timer 22 at the expiration of the specific time interval observes that the service provider B is available and looks into the PRL table to determine if it is more desirable than the current service provider. Since the PRL table B designates service provider B as preferred over service provider A, then the service provider selection logic will cause the mobile to start acquiring service according to the CDMA 2000 1× standard from the service provider B.

Now assume that the mobile telephone 10 requires data only service according to the CDMA 2000 EvDO standard. This service can only be obtained in overlapping areas 204 and 206. If the mobile telephone 10 is within area 204, at position 208 it will acquire service according to the CDMA 2000 EvDO standard from service provider B since this is the only one available at that physical location. The acquisition process generally works on the basis of the linkage information present in the PRL table. In the specific example discussed earlier, the linkage information is in the form of the “ASSN TAG”. Entries sharing the same tag are deemed to be associated. It should be expressly noted, however, that linkage between CDMA 2000 EvDO service providers and CDMA 1× service providers can be established in many other ways without departing from the spirit of the invention. Pointers or any type of relational data or similar mechanisms that would allow establishing that a CDMA 2000 EvDO service provider is linked or associated to a CDMA 2000 1× service provider are intended to be covered by the terminology “linkage information” used in this specification.

To complete this example, when the mobile 10 is at the position 208 and needs services according to the CDMA 2000 EvDO standard, it will follow the linkage information to determine which CDMA 2000 EvDO service provider to use. In the present example, the PRL table contains linkage information between the entry associated with the service provider B (CDMA 2000 1× standard) to the entry also associated with the service provider B but for the CDMA 2000 EvDO standard. At that point the service provider selection logic having identified the service provider to use will cause the mobile 10 to acquire the service according to the CDMA 2000 EvDO standard.

As in the case of the service according to the CDMA 2000 1× standard the service selection logic is invoked periodically by the timer 22 that will assess if the current CDMA 2000 EvDO service provider is the most desirable. While the mobile remains at location 208 such assessment does not bring any change to the current state of service delivery since only one service provider is available.

Assume now that the mobile telephone 10 is outside zones 204 and 206 and enters directly the area of overlap 210. Service according to the CDMA 2000 EvDO standard is available from service provider A and from service provider B in area 210.

The service selection logic is invoked and by following the linkage information it will determine that two CDMA 2000 EvDO service providers are associated or linked with the current CDMA 2000 1× service provider, namely service provider A and service provider B. At that point, the service provider selection logic will assess the relative degree of preference or desirability of both CDMA 2000 EvDO service providers. Recall that in the present example, service provider B is deemed more desirable than service provider A. Finally, the service selection logic causes the mobile telephone 10 to acquire service according to CDMA 2000 EvDO standard from service provider B.

Assume now that the mobile telephone 10 moves deeply within area 206, away from area 204. As the movement occurs, the mobile telephone 10 will progressively go outside the coverage area 204 which will require the service selection logic to acquire service according to the CDMA 2000 EvDO standard from service provider A, since it is the only service provider available.

When the mobile telephone 10 moves back toward area 204 it will reach the overlapping zone 210 where service according to the CDMA 2000 EvDO standard is available from both sources A and B. The timer 22 will invoke the service provider selection logic that will attempt determining if another service provider exists that is more desirable than the current service provider (service provider A). More specifically, the service provider selection logic will look at all the CDMA 2000 EvDO service provider entries in the PRL table that currently are available and select the one that is deemed more desirable on the basis of the preference information. Note that in a non-limiting example of implementation, the search for a more desirable service provider is limited only to those entries sharing a common “ASSN TAG”. Since service provider B is deemed more desirable than service provider A, the service provider selection logic will stop the delivery of service from service provider A and initiate service delivery from service provider B.

Other triggers can also be considered to invoke the service provide selection logic to start searching for another service provider. One possible example is the amount or magnitude of services resources consumed so far by the user from the current service provider. Consider the example of a service plan where after a certain amount of data has been delivered to the mobile telephone 10, the cost of additional data increases significantly. It is then possible to seek another service provider that offers a less expensive data access solution. Yet another possible trigger is the quality of the connection. If the mobile telephone 10 senses that the quality of the connection drops below a certain threshold, measured on the basis of the Frame Error Rate (FER) or more generally, loss of data over the air interface or any other suitable method, the service selection logic is invoked to look for another service provider.

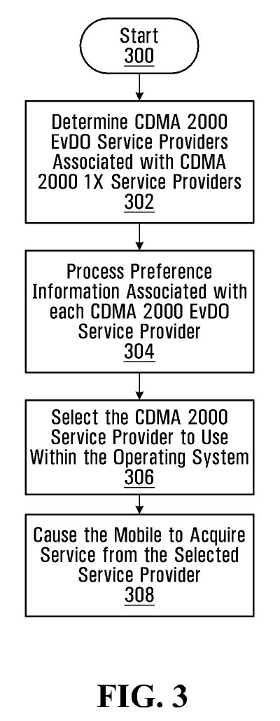

The flowchart on FIG. 3 summarizes in general terms the process for selecting service providers described above. The process is initiated at 300. The process can start as a result of the mobile telephone 10 seeking service according to the CDMA 2000 EvDO standard when no such service is currently being delivered to the mobile or when the service selection logic is invoked by the timer 22 to “hunt” for a more preferred service provider. At step 302 the service selection logic will determine the CDMA 2000 EvDO service providers that are currently available. At steps 304 and 306 the service provider selection logic processes the preference information and selects the service provider that is determined to be the most preferred. At step 308 the service selection logic causes the mobile telephone 10 to acquire service from the selected service provider.

A possible refinement to the examples given above is to design the service provider selection logic such that the periodic assessment is effected only when the current CDMA 2000 EvDO service provider is not the most desirable one. If in fact the current provider is indicated in the PRL table as being the most desirable, there is no point in trying to locate other EvDO service providers in the area in which the mobile telephone 10 is located since those service providers will be deemed less desirable or having the same degree of preference than the current service provider.

Yet another possible variant is to design the service provider selection logic, at step 306, such that it does not automatically switch service providers when a more desirable service provider is identified but merely points this event to the user and lets the user decide if indeed the switch is to be made. This variant can be implemented by delivering to the user a notification, either visual, oral or other that signals the existence of a more desirable service provider, prompting the user for an input that will cause the mobile telephone 10 to acquire service from the service provider deemed more desirable. This option provides the user with an additional level of control on which service provider to use.

It should be expressly noted that while the invention was described in the context of CDMA networks it is not limited to those wireless transmission technologies. The invention can also find applications in Groupe Station Mobile (GSM) wireless technologies, Time Division Multiple Access (TDMA) wireless technologies, General Packet Radio Service (GPRS) wireless technologies, Enhanced Data Rate for GSM Evolution (EDGE) wireless technologies, Wide Band CDMA (WCDMA) wireless technologies which are considered to be a category of CDMA networks, Universal Mobile Telephone System (UMTS) wireless technologies, Hi-Speed Packet Downlink Access (HSPDA) wireless technologies, Time Division Synchronous Code Division Multiple Access (TD-SCDMA) wireless technologies, WiFi (trademark) wireless technologies and World Wide Interoperability for Microwave Access (WiMax) wireless technologies, among others.

In the example of implementation of the invention described earlier, the CDMA 2000 EvDO service providers that the mobile telephone 10 is allowed to use are those linked to a CDMA 1× service provider. It should be expressly noted that this characteristic is optional and may be omitted without departing from the spirit of the invention. Specifically embodiments can be considered where no linkage exists between the sets of wireless entities that operate according to the different wireless communication standards. In this fashion, when the mobile telephone 10 acquires service according to a given standard, say CDMA 2000 EvDO it is not constrained only to entries that are linked with the service provider delivering service according to the other standard (CDMA 1×).

Another possible variant that can be considered without departing from the spirit of the invention is using service provider selection logic that is dedicated to each wireless communication standard. The example described earlier assumed that the same logic was invoked for making a selection for each standard. This is not necessary and one can provide separate logic blocks, where each block is specifically designed to handle the selection process among the wireless entities operating according to a given standard.

Although various embodiments have been illustrated, this was for the purpose of describing, but not limiting, the invention. Various modifications will become apparent to those skilled in the art and are within the scope of this invention, which is defined more particularly by the attached claims. In particular, although the invention is discussed here as a wireless mobile telephone, it is also applicable to any other form of wireless communication.

1) A wireless device capable of acquiring service from at least two wireless entities, said wireless device comprising:
a) a data storage area for holding a data structure comprising:
i) information about a first set of wireless entities, said first set of wireless entities being based on a first wireless communication standard to deliver wireless service;
ii) information about a second set of wireless entities, said second set of wireless entities being based on a second wireless communication standard to deliver wireless service, wherein the first wireless communication standard is different from the second wireless communication standard;
iii) first preference information indicating that one of the wireless entities from the first set is more desirable than another one of the wireless entities from the first set;
iv) second preference information indicating that one of the wireless entities from the second set is more desirable than another one of the wireless entities of the second set;
b) selection logic operable for:
i) using the first preference information in selecting a wireless entity from the first set of wireless entities;
ii) using the second preference information in selecting a wireless entity from the second set of wireless entities.

2) A wireless device as defined in claim 1 wherein said data storage area comprises linkage information for linking at least two of the wireless entities from the second set to at least one wireless entity from the first set.

3) A wireless device as defined in claim 1, wherein said selection logic is operative to cause said wireless device to acquire service from the wireless entity selected by said selection logic among the wireless entities from the second set.

4) A wireless device as defined in claim 3, wherein when said wireless device is in a state of acquiring service based on the first wireless communication standard, said selection logic is operative for using the second preference information in selecting a wireless entity from the second set before acquiring service based on the second wireless communication standard.

5) A wireless device as defined in claim 2, wherein when said wireless device is in a state of acquiring service from a given wireless entity from the first set, said selection logic is operative for using the second preference information in selecting a wireless entity only among the wireless entities from the second set linked to the given wireless entity before acquiring service based on the second wireless communication standard.

6) A wireless device as defined in claim 3, wherein when said wireless device has acquired service from a certain wireless entity of the second set, said selection logic is capable of determining if service can also be acquired from another wireless entity of the second set that is indicated by the second preference information as being more desirable than the certain wireless entity.

7) A wireless device as defined in claim 6, wherein said data storage area for holding a data structure further comprises linkage information for linking at least two of the wireless entities from the second set to at least one wireless entity from the first set and wherein said selection logic is capable of determining if service can also be acquired from another wireless entity from the second set that is indicated by the second preference information as being more desirable than the certain wireless entity, only among the wireless entities from the second set that are linked to a common wireless entity from the first set.

8) A wireless device as defined in claim 1, wherein the first and second wireless communication standards provide different service attributes to the user of the wireless device.

9) A wireless device as defined in claim 1, wherein the second wireless communication standard provides a higher data rate data service than the first wireless communication standard.

10) A wireless device as defined in claim 1, wherein the first wireless communication standard is based on signal transmission technology selected in the group consisting of CDMA, GSM, TDMA, GPRS, EDGE, UMTS, HSPDA, TD-SCDMA, WiFi and WiMax.

11) A wireless device as defined in claim 1, wherein the second wireless communication standard is based on signal transmission technology selected in the group consisting of CDMA, GSM, TDMA, GPRS, EDGE, UMTS, HSPDA, TD-SCDMA, WiFi and WiMax.

12) A wireless device as defined in claim 1, wherein the first wireless communication standard supports voice calls.

13) A wireless device as defined in claim 1, wherein the first wireless communication standard supports voice and data communications.

14) A wireless device as defined in claim 1, wherein the second wireless communication standard supports only data communications.

15) A wireless device as defined in claim 1, wherein the first wireless communication standard is CDMA 2000 1×.

16) A wireless device as defined in claim 15, wherein the second wireless communication standard is CDMA 2000 EvDO.

17) A wireless device as defined in claim 6, wherein said selection logic attempts determining if service can also be acquired from another wireless entity from said second set only if the certain wireless entity is not indicated by the second preference information as being the most desirable wireless entity.

18) A wireless device as defined in claim 1, wherein one or more of the wireless entities of the second set are wireless service providers.

19) A wireless device as defined in claim 1, wherein one or more of the wireless entities of the second set are wireless networks.

20) A wireless device as defined in claim 1, wherein one or more of the wireless entities of the first set are wireless service providers.

21) A wireless device as defined in claim 1, wherein one or more of the wireless entities of the first set are wireless networks.

22) A wireless device as defined in claim 1, wherein the first and second wireless communication standards are cellular communication standards.

23) A wireless device as defined in claim 1, wherein the device is selected from the group consisting of mobile telephone, gaming apparatus, wireless device having e-mail reception and transmission capability, PDA, wireless device having video reception and display capability and a vehicular apparatus.

24) A computer readable storage medium for program data for execution by a processor of a wireless device, the wireless device having:
a) a data storage area for holding a data structure, containing:
i) information about a first set of wireless entities, the first set of wireless entities being capable of delivering wireless service based on a first wireless communication standard;
ii) information about a second set of wireless entities, the second set of wireless entities being capable of delivering wireless service based on a second wireless communication standard, different than the first wireless communication standard;
iii) first preference information indicating that one of the wireless entities from the first set is more desirable than another one of the wireless entities from the first set;
iv) second preference information indicating that one of the wireless entities from the second set is more desirable than another one of the wireless entities of the second set.
b) said program data when executed by the processor of the wireless device implementing a selection logic operable for:
i) using the first preference information in selecting a wireless entity from the first set of wireless entities;
ii) using the second preference information in selecting a wireless entity from the second set of wireless entities.

20) A computer readable storage medium as defined in claim 24 wherein the data structure further comprises linkage information for linking at least two of the wireless entities from the second set to at least one wireless entity from the first set.

21) A computer readable storage medium as defined in claim 24, wherein said selection logic is operative to cause the wireless device to acquire service from the wireless entity selected among the wireless entities from the second set.

22) A computer readable storage medium as defined in claim 26, wherein when the wireless device is in a state of acquiring service based on the first wireless communication standard, said selection logic is operative for using the second preference information in selecting a wireless entity from the second set before acquiring service based on the second wireless communication standard.

23) A computer readable storage medium as defined in claim 26, wherein the data structure further comprises linkage information for linking at least two of the wireless entities from the second set to at least one wireless entity from the first set and wherein when the wireless device is in a state of acquiring service based on the first wireless communication standard from a given wireless entity, said selection logic is operative for using the second preference information in selecting a wireless entity only among the wireless entities of the second set linked to the given wireless entity before acquiring service based on the second wireless communication standard.

24) A computer readable storage medium as defined in claim 26, wherein when the wireless device has acquired service from a certain wireless entity of the second set, said selection logic is capable of determining if service can also be acquired from another wireless entity of the second set that is indicated by the second preference information as being more desirable than the certain wireless entity.

25) A computer readable storage medium as defined in claim 28, wherein when the wireless communication device has acquired service from a certain wireless entity of the second set said selection logic is capable of determining if service can also be acquired from another wireless entity from the second set that is indicated by the second preference information as being more desirable than the certain wireless entity, only among the wireless entities of the second set that are linked to a common wireless entity from the first set.

26) A computer readable storage medium as defined in claim 24, wherein the first and second wireless communication standards provide different service attributes to the user of the wireless device.

27) A computer readable storage medium as defined in claim 24, wherein the second wireless communication standard provides a higher data rate data service than the first wireless communication standard.

28) A computer readable storage medium as defined in claim 24, wherein the first wireless communication standard is based on signal transmission technology selected in the group consisting of CDMA, GSM, TDMA, GPRS, EDGE, UMTS, HSPDA, TD-SCDMA, WiFi and WiMax.

29) A computer readable storage medium as defined in claim 24, wherein the second wireless communication standard is based on signal transmission technology selected in the group consisting of CDMA, GSM, TDMA, GPRS, EDGE, UMTS, HSPDA, TD-SCDMA, WiFi and WiMax.

30) A computer readable storage medium as defined in claim 24, wherein the first wireless communication standard allows voice calls.

31) A computer readable storage medium as defined in claim 24, wherein the first wireless communication standard allows voice and data communications.

32) A computer readable storage medium as defined in claim 24, wherein the second wireless communication standard allows only data communications.

33) A computer readable storage medium as defined in claim 24, wherein the first wireless communication standard is CDMA 2000 1×.

34) A computer readable storage medium as defined in claim 38, wherein the second wireless communication standard is CDMA 2000 EvDO.

35) A computer readable storage medium as defined in claim 26, wherein said selection logic attempts determining if service can also be acquired from another wireless entity from the second set only if the certain wireless entity is not indicated by the second preference information as being the most desirable wireless entity among the wireless entities.

36) A computer readable storage medium as defined in claim 24, wherein one or more of the wireless entities of the second set are wireless service providers.

37) A computer readable storage medium as defined in claim 24, wherein one or more of the wireless entities of the second set are wireless networks.

38) A computer readable storage medium as defined in claim 24, wherein one or more of the wireless entities of the first set are wireless service providers.

39) A computer readable storage medium as defined in claim 24, wherein one or more of the wireless entities of the first set are wireless networks.

40) A computer readable storage medium as defined in claim 24, wherein the first and second wireless communication standards are cellular communication standards.

41) A computer readable storage medium as defined in claim 24, wherein the device is selected from the group consisting of mobile telephone, gaming apparatus, wireless device having e-mail reception and transmission capability, PDA, wireless device having video reception and display capability and a vehicular apparatus.

42) A mobile cellular telephone capable of wireless communications based on a first wireless communication standard and on a second wireless communication standard, wherein:
a) the first wireless communication standard is CDMA based and supports voice and data communications;
b) the second wireless communication standard is CDMA based and supports data only communications, the second wireless communication standard allowing a higher data transfer rate with said mobile cellular telephone than the first wireless communication standard;
c) service based on the second wireless communication standard can be provided to said mobile telephone by two or more service providers, said mobile telephone comprising:
i) a data storage area for holding information about a plurality of service providers and information indicating that one service provider is more desirable than another service provider;
ii) service provider selection logic for processing information in said data storage area to determine when said mobile telephone has acquired service from one service provider, if service can also be acquired from another service provider that is indicated in said data storage area as being more desirable than the one service provider.

43) A mobile cellular telephone as defined in claim 47, wherein said information about a plurality of service providers and information indicating that one service provider is more desirable than another service provider is organized in a PRL table.

44) A mobile cellular telephone as defined in claim 47, wherein the first wireless communication standard is CDMA 2000 1×.

45) A mobile cellular telephone as defined in claim 47, wherein the second wireless communication standard is CDMA EvDO.

46) A method for selecting a wireless entity for the delivery of service to a wireless device, the method comprising:
selecting a wireless entity from a first set of wireless entities using first preference information, said first set of wireless entities being capable of delivering wireless service based on a first wireless communication standard, and said first preference information indicating that one of the wireless entities from the first set is more desirable than another one of the wireless entities from the first set; and
selecting a wireless entity from a second set of wireless entities using second preference information, said second set of wireless entities being capable of delivering wireless service based on a second wireless standard different than the first wireless standard, and said second preference information indicating that one of the wireless entities from the second set is more desirable than another one of the wireless entities from the second set.

52) A method as defined in claim 51 wherein said selecting a wireless entity from a second set uses linkage information for linking at least two of the wireless entities from the second set to at least one wireless entity from the first set.

53) A method as defined in claim 51, further comprising causing the wireless device to acquire service from the wireless entity selected among the two or more of the wireless entities from the second set.

54) A method as defined in claim 53, wherein when the wireless device is in state of acquiring service based on the first wireless standard, said method further comprises using the second preference information in selecting a wireless entity from the second set before acquiring service based on the second wireless standard.

55) A method as defined in claim 52, wherein when the wireless device is in a state of acquiring service based on the first wireless standard from a given wireless entity, said method further comprises using the second preference information in selecting a wireless entity only among the wireless entities of the second set linked to the given wireless entity before acquiring service based on the second wireless standard.

56) A method as defined in claim 53, wherein when the wireless device has acquired service from a certain wireless entity of the second set, said method further comprises determining if service can also be acquired from another wireless entity of the second set that is indicated by the second preference information as being more desirable than the certain wireless entity.

57) A method as defined in claim 55, further comprising determining if service can also be acquired from another wireless entity from the second set that is indicated by the second preference information as being more desirable than the certain wireless entity, only among the wireless entities of the second set that are linked to a common wireless entity from the first set.

58) A method as defined in claim 51, wherein the first and second wireless communication standards provide different service attributes to the user of the wireless device.

59) A method as defined in claim 51, wherein the second wireless standard provides a higher data rate data service than the first wireless communication standard.

60) A method as defined in claim 51, wherein the first wireless communication standard is based on signal transmission technology selected in the group consisting of CDMA, GSM, TDMA, GPRS, EDGE, UMTS, HSPDA, TD-SCDMA, WiFi and WiMax.

61) A method as defined in claim 51, wherein the second wireless communication standard is based on signal transmission technology selected in the group consisting of CDMA, GSM, TDMA, GPRS, EDGE, UMTS, HSPDA, TD-SCDMA, WiFi and WiMax.

62) A method as defined in claim 51, wherein the first wireless communication standard allows voice calls.

63) A method as defined in claim 51, wherein the second wireless communication standard allows voice and data communications.

64) A method as defined in claim 51, wherein the second wireless communication standard allows only data communications.

65) A method as defined in claim 51, wherein the first wireless communication standard is CDMA 2000 1×.

66) A method as defined in claim 65, wherein the second wireless communication standard is CDMA 2000 EvDO.

67) A method as defined in claim 56, further comprising determining if service can also be acquired from another wireless entity from the second set only if the certain wireless entity is not indicated by the second preference information as being the most desirable wireless entity among the wireless entities.

68) A method as defined in claim 51, wherein one or more of the wireless entities of the second set are wireless service providers.

69) A method as defined in claim 51, wherein one or more of the wireless entities of the second set are wireless networks.

70) A method as defined in claim 51, wherein one or more of the wireless entities of the first set are wireless service providers.

71) A method as defined in claim 51, wherein one or more of the wireless entities of the first set are wireless networks.

72) A method as defined in claim 51, wherein the first and second wireless communication standards are cellular communication standards.

73) A method as defined in claim 51, wherein the device is selected from the group consisting of mobile telephone, gaming apparatus, wireless device having e-mail reception and transmission capability, PDA, wireless device having video reception and display capability and a vehicular apparatus.

74) A wireless device capable of acquiring service from at least two wireless entities, said wireless device comprising:
a) means for storing a data structure comprising:
i) information about a first set of wireless entities, said first set of wireless entities being based on a first wireless communication standard to deliver wireless service;
ii) information about a second set of wireless entities, said second set of wireless entities being based on a second wireless communication standard to deliver wireless service, wherein the first wireless communication standard is different from the second wireless communication standard;
iii) first preference information indicating that one of the wireless entities from the first set is more desirable than another one of the wireless entities from the first set;
iv) second preference information indicating that one of the wireless entities from the second set is more desirable than another one of the wireless entities of the second set;
b) means for selecting a wireless entity from the first set of wireless entities using the first preference information;
c) means for selecting a wireless entity from the second set of wireless entities using the second preference information.
